(19) United States
(12) Patent Application Publication
(10) Pub. No.: US 2004/0061339 A1
(43) Pub. Date: Apr. 1, 2004

(54) Solenoid arrangement for controlling handle operation in a door lock

(76) Inventor: Jaakko Lemettinen, Joensuu (FI)

Correspondence Address: SMITH-HILL AND BEDELL, 12670 N W BARNES ROAD, SUITE 104, PORTLAND, OR, 97229

(21) Appl. No.: 10/451,006

(22) PCT Filed: Jan. 17, 2002
(86) PCT No.: PCT/FI02/00037

(30) Foreign Application Priority Data
Jan. 24, 2001 (FI) 20010140

(51) Int. Cl. E05C 3/06

(52) U.S. Cl. 292/201

(57) ABSTRACT

A solenoid arrangement for controlling handle operation in a door lock, in which force transmission from an operation axis of a handle or the like to a follower acting on a bolt of the lock is arranged by means of a movable coupling member which receives its guidance from the solenoid arrangement. The arrangement includes a shaft element which is arranged to move through a solenoid against the force of a spring and which moves a turnable lever member selecting the operating position of said coupling member. The position of the turning axis of the said lever member with regard to the coupling member is arranged to be selectively changed to provide a desired handle operation.

The invention relates to a solenoid arrangement for controlling handle operation in a door lock, in which force transmission from an operation axis of a handle or the like to a follower acting on a bolt of the lock is arranged by means of a movable coupling member which receives its guidance from the solenoid arrangement in accordance with the preamble of claim 1.

Control of a handle operation in a door lock by means of a solenoid arrangement can be accomplished in different ways depending on the application. The arrangement may for instance be such that when the solenoid is energized it allows or makes it possible the right to passage by using a handle, whereby, thus, force transmission from the handle to the bolt of the lock is coupled. Alternatively the solution may be reversed so that the arrangement allows the right to passage by using a handle when the solenoid is de-energized. The way of operation of the arrangement depends on whether stress is laid on the security of the right to passage or getting out from the locked space or on the security of the locked space as such. In practice the arrangement is usually such that from outside the door can always be opened by means of a key operated lock mechanism of the like and from inside by means of a handle, a turning knob or the like, whereby selective coupling of the handle operation presumes at the same time a two-piece or divided shaft of operation.

A practical problem included in the arrangements described above is that two separate lock case versions are needed for the door lock, one for each way of operation.

An aim of the invention is to provide a novel solution of the kind in which the same basic parts to be installed in the lock case can be utilized for both the ways of operation described above and in which the selection of the way of operation can be accomplished in a simple way from outside without opening the lock case itself. A further aim is that the arrangement is advantageous as to manufacturing technique and secure as to operation and does not require too much space in the lock case.

The aims of the invention can be met as is described more closely in claim 1 and in the other claims. According to the invention the arrangement includes a shaft element which is arranged to move through a solenoid against the force of a spring and which moves a turnable lever member selecting the operating position of said coupling member. In addition the position of the turning axis of the said lever member with regard to the coupling member is arranged to be selectively changed to provide a desired handle operation. The solution is thus essentially based on the fact that the turning axis of the lever member to be used can be located in different places and the place can easily be changed if needed.

In a practical embodiment of advantage the lever member is supported to the shaft element so that the position of the turning axis of the lever member can be changed from one side of the shaft element to the other, whereby certain movement of the shaft element provides turning of the head of the lever member in different direction with regard to the coupling member.

A compact arrangement is accomplished if the turning axis of the lever member is parallel with said operation axis. In this case the arrangement may with advantage include a selecting member installed outside the lock case of the door lock, comprising a stub shaft which can be inserted inside the lock case so that it is in cooperation with the lever member and serves as its turning axis in each case.

A solution advantageous from the viewpoint of utilization of space and security is accomplished in case the lever member includes two sleeve-like elements for said stub shaft so that one of the sleeve-like elements is located on the end of the lever member opposite with regard to the coupling member.

Changing of the location of the turning axis of the lever member can be accomplished in a simple way by changing the position or set of the selecting member. After selecting the desired way of operation the selecting member can with advantage be fixed to the lock case by means of a screw or the like.

In one embodiment of the invention the end of the lever member close to the coupling member is provided with a magnet for attracting the coupling member.

In the following the invention is described by way of example with reference to the attached drawings in which

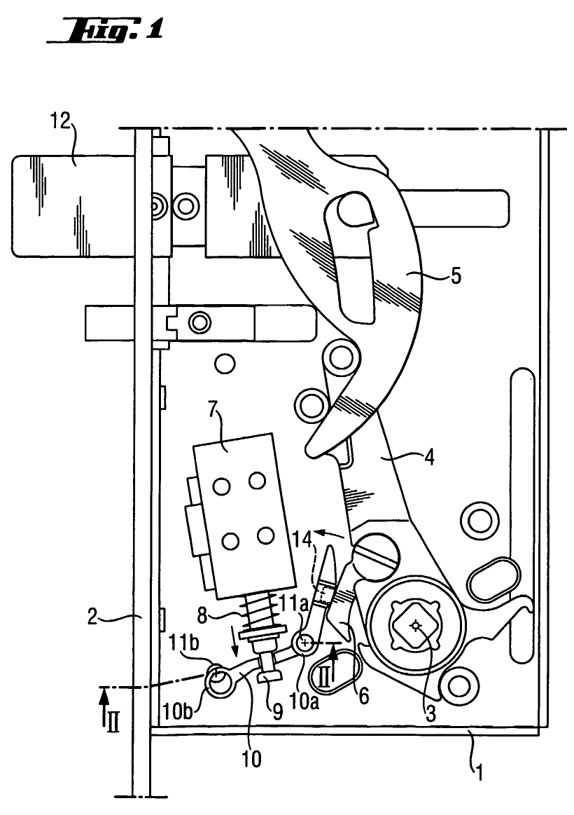

FIG. 1 shows an embodiment of a solenoid arrangement for a door lock according to the invention as a side view and the lock case opened,

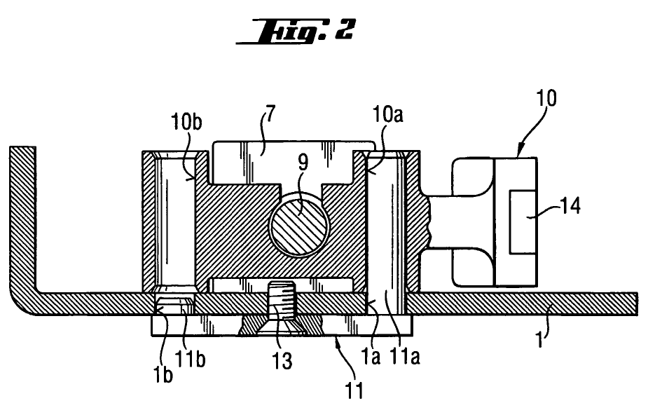

FIG. 2 shows section II-II of FIG. 1 as an enlargement,

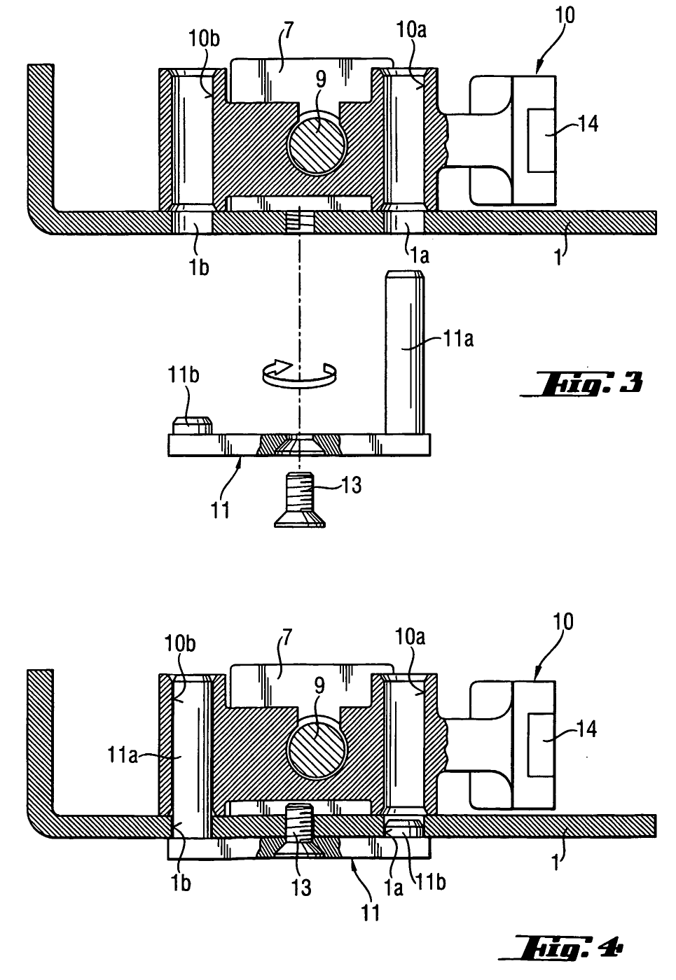

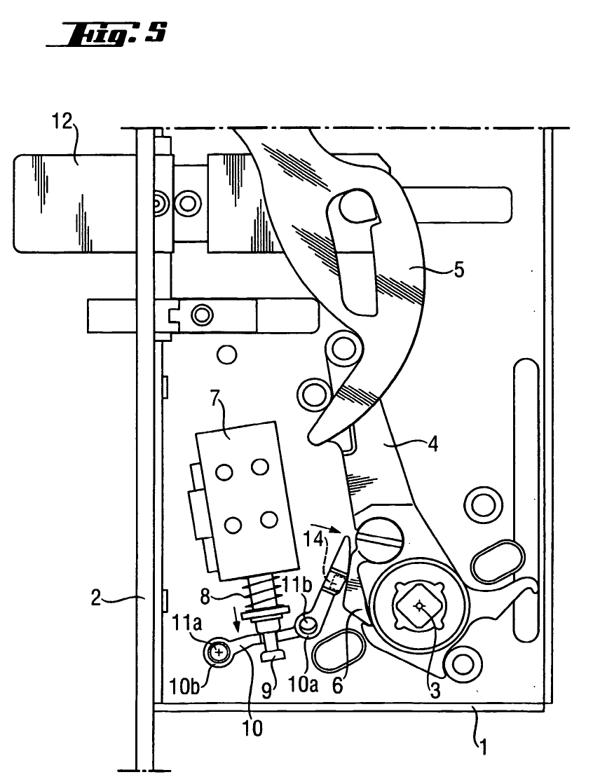

FIGS. 3 and 4 illustrate selection of the way of operation of a handle as a sectional view corresponding to FIG. 2,

FIG. 5 shows the embodiment of FIG. 2 after providing a change of the way of operation of a handle.

In the drawings the reference numeral 1 indicates a lock case of a door lock having a cover which in the figures is shown partly opened. The lock case 1 is provided with a front plate 2 through which a bolt 12 of the lock is movable. The lock case 1 is additionally provided with an operation axis 3, to which is installed a follower 4 which is turnably journalled to the lock case and which in the embodiment shown acts on the bolt of the lock through a separate force transmission lever 5. Naturally, when desired the follower can be arranged to move the bolt of the lock also directly.

In practice the follower 4 can be affected from both sides of the lock. A key operated lock mechanism or the like, which is provided with a torsion arm or a corresponding force transmission element (not shown) acting directly on the follower 4, is installed on the operation axis 3 on one side of the lock case in a way known as such. Alternatively, depending on the situation also a handle or the like may be installed so that its spindle extends to and acts directly on the follower 4. Hereby the door can always be opened from this side. On the other side of the lock case a handle, a turn knob or the like is installed on the operation axis 3, a not-shown spindle of which is independent on the said force transmission element of the lock mechanism or said alternative handle arrangement so that the handle operation can correspondingly be controlled independently. The force transmission required by the handle operation is arranged by means of a coupling member 6, which has two selectable operating positions, a force transmission coupling position, in which the bolt of the lock can be moved by means of the handle, and a force transmission decoupling position, in which the bolt of the lock correspondingly cannot be affected by means of the handle.

Control of the handle operation occurs with an arrangement according to the invention, including a solenoid 7, which moves a shaft element 9 against the force of a spring 8. Arranged on the shaft element 9 there is a lever member 10 which acts on the coupling member 6 so that by means of it, it is possible to select whether or not the coupling member 6 is in its position connecting the force transmission.

The lever member 10 is provided with sleeve elements 10a and 10b, which are located on different sides of the shaft element 9. The arrangement includes also a selecting member 11 to be fixed by means of a screw 13 outside to the lock case 1 and which is provided with a long stub shaft 11a and a short stub shaft 11b. The selecting member 11 can be arranged in cooperation with the lever member 10 so that the long stub shaft 11a is located in either one of the sleeve elements 10a and 10b. The lock case 1 has apertures 1a and 1b for the stub shafts 11a and 11b.

In the situation of FIGS. 1 and 2 the solenoid 7 is not powered, whereby the spring 8 presses the shaft element 9 in the direction of the arrow. Due to this the lever member 10 is turned through its sleeve element 10a around the long stub shaft 11a of the selecting member 11 in the counter clock-wise direction as indicated in FIG. 1. The lever member 10 is in this case provided with a magnet 14, which attracts the coupling member 6 into a non-coupling position, whereby a handle installed to the operation axis 3 is not in force transmission connection with the follower 4 and thus with the bolt of the lock either. Instead of the magnet 14, when desired, the follower 6 may also be moved by means of spring force.

Correspondingly when power is connected to the solenoid 7 it moves the shaft element 9 against the force of the spring 8, whereby the lever member 10 turns in the clock-wise direction and presses the coupling member 6 into its coupling position. For the matter of simplicity there is no disclosure of power supply in the figures.

The FIGS. 3 and 4 illustrate how control of the handle operation can be changed by changing the position of the selecting member 11. This is simply carried out so that the screw 13 is detached and the selecting member 11 is turned half a turn, so that the position of the stub shafts 11a and 11b in the apertures 1a and 1b is changed. In this situation the long stub shaft 11a is located in the sleeve element 10b. As a consequence of this, in the way shown in FIG. 5, when the solenoid 7 is without power and the spring 8 is pressing the shaft element 9 in the direction of the arrow the lever member 10 is turned through its sleeve element 10b in the clock-wise direction as indicated by the arrow, whereby at the same time it presses the coupling member 6 into its coupling position. Hereby a handle installed to the operation axis 3 is in force transmission connection with the follower 4 and it is possible to operate the bolt of the lock with it. If power is connected to the solenoid 7 in this situation, the direction of the movements of the different members are changed and the coupling member 6 moves because of the magnet 14 into its non-coupling position.

The invention is not limited to the embodiment shown, but several modifications are feasible within the scope of the attached claims.

1. A solenoid arrangement for controlling handle operation in a door lock, in which force transmission from an operation axis (3) of a handle or the like to a follower (4) acting on a bolt (12) of the lock is arranged by means of a movable coupling member (6) which receives its guidance from the solenoid arrangement, characterised in that it includes a shaft element (9) which is arranged to move through a solenoid (7) against the force of a spring (8) and which moves a turnable lever member (10) selecting the operating position of said coupling member (6), and in that the position of the turning axis of the said lever member (10) with regard to the coupling member (6) is arranged to be selectively changed to provide a desired handle operation.

2. A solenoid arrangement according to claim 1, characterised in that the lever member (10) is supported to the shaft element (9) so that the position of the turning axis of the lever member (10) can be changed from one side of the shaft element (9) to the other, whereby certain movement of the shaft element (9) provides turning of the head of the lever member (10) in different direction with regard to the coupling member (6).

3. A solenoid arrangement according to claim 1 or 2, characterised in that the turning axis of the lever member (10) is parallel with said operation axis (3).

4. A solenoid arrangement according to any one of the preceding claims, characterised in that it includes a selecting member (11) installed outside the lock case (1) of the door lock, comprising a stub shaft (11a) which can be inserted inside the lock case (1) so that it is in cooperation with the lever member (10) and serves as its turning axis in each case.

5. A solenoid arrangement according to claim 4, characteris d in that the lever m mber (10) includes two sleeve-like elements (10a, 10b) for said stub shaft (11a) and in that one of the sleeve-like elements (10b) is located on the end of the lever member opposite with regard to the coupling member (6).

6. A solenoid arrangement according to claim 4 or 5, characterised in that changing of the location of the turning axis of the lever member (10) is arranged by changing the position or set of the selecting member (11).

7. A solenoid arrangement according to any one of the claims 4-6, characterised in that the selecting member (11) is fixable to the lock case (1) by means of a screw (13) or the like.

8. A solenoid arrangement according to any one of the preceding claims, characterised in that the end of the lever member (10) close to the coupling member (6) is provided with a magnet (14) for attracting the coupling member (6).
